(19) United States
(12) Patent Application Publication
(10) Pub. No.: US 2010/0153311 A1
(43) Pub. Date: Jun. 17, 2010

(54) PLANAR ADVERTISING SYSTEM AND METHOD

(76) Inventor: Raelene Denyce McCormick, Western Australia (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/439,512

(22) PCT Filed: Aug. 28, 2007
(86) PCT No.: PCT/AU2007/001245

§ 371 Date: Dec. 18, 2009

(30) Foreign Application Priority Data
Aug. 28, 2006 (AU) 2006904670

(51) Int. Cl. G06Q 90/00

(52) U.S. Cl. 705/500

(57) ABSTRACT

A method and system for advertising in a car park (1) or other parking area having a number of car parking bays (2) provided thereon. The car parking bays are provided with graphical regions (4, 5, 6) provided within the car parking bays, specifically down the sides of the bays and across the head of the bay. These graphical areas constitute advertising. In the method of advertising a third party contracts with the car park owner and sells the advertising space to relevant advertisers. In an alternative, the advertising can be provided as graphic regions at the end of the bays. The graphics are created using specific stencils and paint to create clear graphics.

### FIELD OF THE INVENTION

The present invention relates to a method and system of advertising, and a method of creating advertisements provided on a substantially planar surface, particularly, although not exclusively, in car parks or other public areas.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background to the invention is intended to facilitate an understanding of the present invention. However, it should be appreciated that the discussion is not an acknowledgement or admission that any of the material referred to was published, known or part of the common general knowledge of the person skilled in the art in any jurisdiction as at the priority date of the invention.

The facilitation cost, maintenance cost and opportunity cost of providing a vehicle parking facility for public use can be substantial. These costs include the cost of maintaining the parking surface, the cost of providing security staff to monitor the facility, the cost of cleaning and maintaining the area including the return of short-term loan items such as shopping trolleys, the costs associated with any landscaping or other decoration, and finally, the opportunity cost of the real estate that the vehicle storage facility is provided on.

One way to recoup some of these costs is to charge the user of the car park a fee, which in turn subsidises or alleviates such costs. However, in the case of a car park that is provided adjacent a retail outlet or service facility, the imposition of car parking charges can act as a disincentive to the potential users and customers.

Removing access to car parking—while reducing overheads for the owners of the car park—can also act as a disincentive to the customers and users who may well travel to other facilities that have access to parking.

### DISCLOSURE OF THE INVENTION

According to a first aspect of the present invention, there is provided an advertising system provided within a vehicle parking area, the vehicle parking area comprising a substantially planar surface having a plurality of delineated portions for parking of a vehicle therein, whereby the delineated portions comprise a substantially planar primary advertising portion provided on a section of the substantially planar surface.

Preferably, the delineated portions are defined by a pair of substantially parallel lines provided on the substantially planar surface whereby the primary advertising portion is provided substantially perpendicular to the pair of parallel lines and between opposing ends of each of the pair of parallel lines.

Preferably, the delineated portions are defined by a pair of substantially parallel elongate areas comprising a second advertising area, and by the primary advertising area provided substantially perpendicular to the pair of parallel lines and between opposing ends of each of the pair of substantially parallel elongate areas.

Alternatively, the delineated portions are defined by a pair of substantially parallel lines provided on the substantially planar surface whereby the primary advertising portion is a blocked area provided adjacent the ends of one or both of the pair of substantially parallel lines.

Preferably, the blocked area is oval in shape.

In accordance with a second aspect of the present invention, there is provided a method for creating an advertising system for areas, having a substantially horizontal planar surface, the advertising system comprising a primary advertising portion provided upon the substantially planar surface painted thereon, the primary advertising portion comprising painted graphics, the method comprising the steps of:
preparing the substantially planar surface;
masking portions of the area to define the primary advertising portion;
providing a base material in the defined primary advertising portion;
providing a coat of material on the base material; and
creating graphics on the coat using a stencil.

Preferably, the masking is achieved using a straight edge material. Alternatively, the masking is achieved using a masking tape, or using rubber matting.

Preferably, the graphics are applied using an airless spray system and paint gun.

Preferably, the method further comprises the step of adding a phosphorescent coating.

Preferably, the area comprises a public external area.

In accordance with a third aspect of the present invention, there is provided a method of advertising goods and/or services by providing advertising on a substantially horizontal planar surface provided in an area, whereby the advertising is in a primary advertising portion painted on the substantially horizontal planar surface.

Preferably, the method further comprises the step of providing a secondary advertising portion, whereby the secondary advertising portion comprises first and second substantially parallel elongate rectangular areas, and the primary advertising portion comprising a third substantially rectangular area arranged between the first and second rectangular areas to thereby delineate a substantially rectangular portion of the area.

Alternatively, the method comprises the steps of providing first and second substantially parallel lines on the substantially horizontal planar surface, the first and second substantially parallel lines delineating a substantially rectangular portion of the area, whereby the primary advertising portion is substantially oval in shape and is provided at a free end of the substantially parallel lines.

Alternatively, the area comprises a defined pedestrian area, the primary advertising portion being provided on the pedestrian area.

Preferably, the area comprises a public external area.

In accordance with a fourth aspect of the present invention, there is provided a method of advertising comprising the steps of: contracting with the owner of an area to provide advertising services; providing advertising spaces within the area; and selling the advertising spaces to advertisers.

Preferably, the area comprises a public external area.

In accordance with a fifth aspect of the present invention, there is provided a stencil for use in creating graphics for a substantially horizontal surface comprising a metallic sheet having one or more apertures provided therein.

Preferably, the apertures are linked by one or more bridges.

Preferably, the bridges have a width of less than 2 mm.

Preferably, the substantially horizontal surface is an exterior surface.

### BRIEF DESCRIPTION OF THE DRAWINGS

The present invention will now be described, by way of example, with reference to the accompanying drawings, in which:

FIG. 1 is a schematic perspective illustration of a section of a conventional car park illustrating the use of conventional car park bays for parking vehicles therein;

FIG. 2 is a schematic overhead illustration of a section of a car park incorporating one or more car parking bays in accordance with an aspect of the present invention;

FIG. 3 is a detailed overhead view of a car parking bay in accordance with an aspect of the present invention;

FIGS. 4A to 4F illustrate the steps used to create the car parking bay of FIG. 2;

FIG. 5 illustrates a stencil used in the methods illustrated in FIGS. 4A to 4F;

FIG. 6 illustrates the dimensions of the advertising areas of a car parking bay in accordance with an aspect of the present invention;

FIG. 7 illustrates an alternative arrangement for a car parking bay; and

FIG. 8 illustrates the provision of advertisements on a cross walk in accordance with another aspect of the present invention.

### BEST MODE(S) FOR CARRYING OUT THE INVENTION

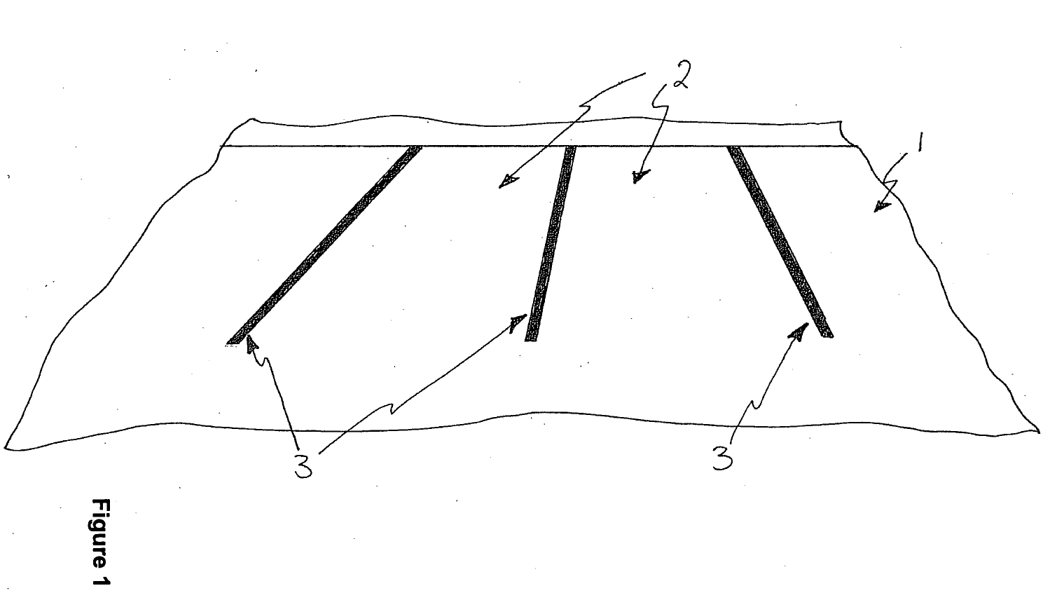

FIG. 1 schematically illustrates a conventional car park 1 with conventional car parking bays 2. As is known in the art, car parking bays 2 are created by providing a multiplicity of substantially parallel lines 3, any pair of adjacent substantially parallel lines defining a single parking bay. The separation and length of the lines 3 is chosen to define a substantially rectangular area that is sufficient for a car to park therein while allowing room for passengers to exit and enter the vehicle when cars are parked in adjacent bays. In practice the actual dimensions can vary, and are often arranged to accommodate as many vehicles as possible.

In many instances a number of car parking bays are set aside or reserved for people with specific needs. For example, some are reserved for disabled persons, some for elderly persons, and some for parents with young children.

These reserved bays are usually identifiable by a simple sign painted on the surface of the car park, within the reserved bay. Conventionally, bays for disabled persons have specific marking—for example, by painting the car parking bay surface blue (in Australia) or painting the lines 3 blue.

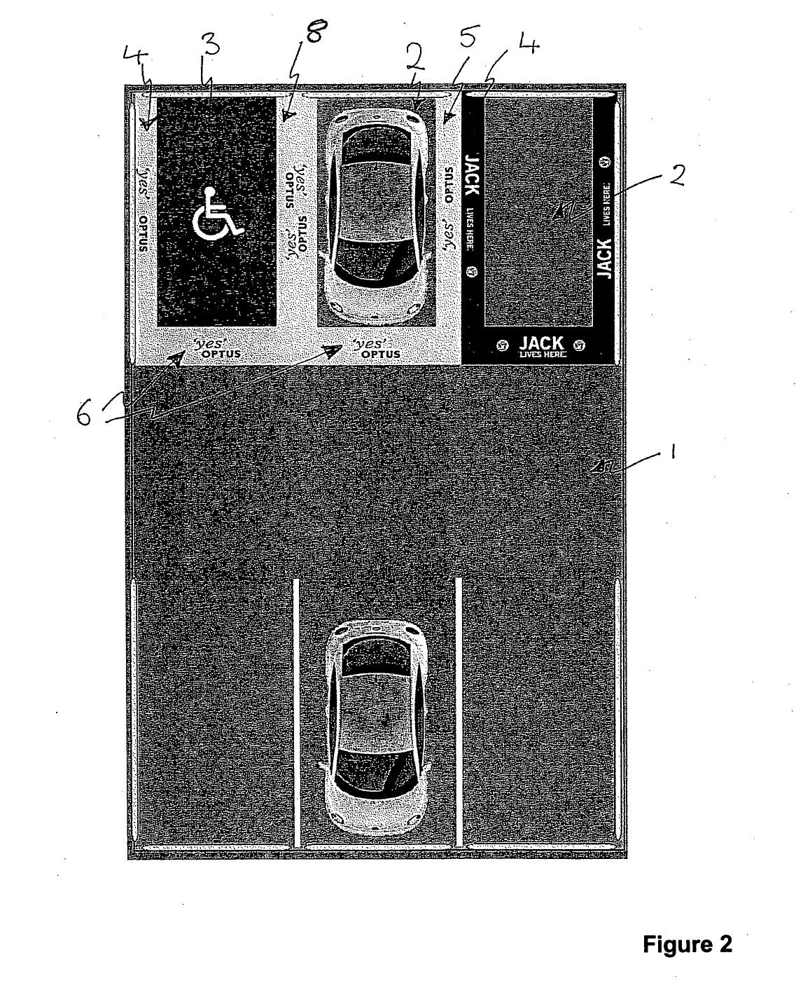

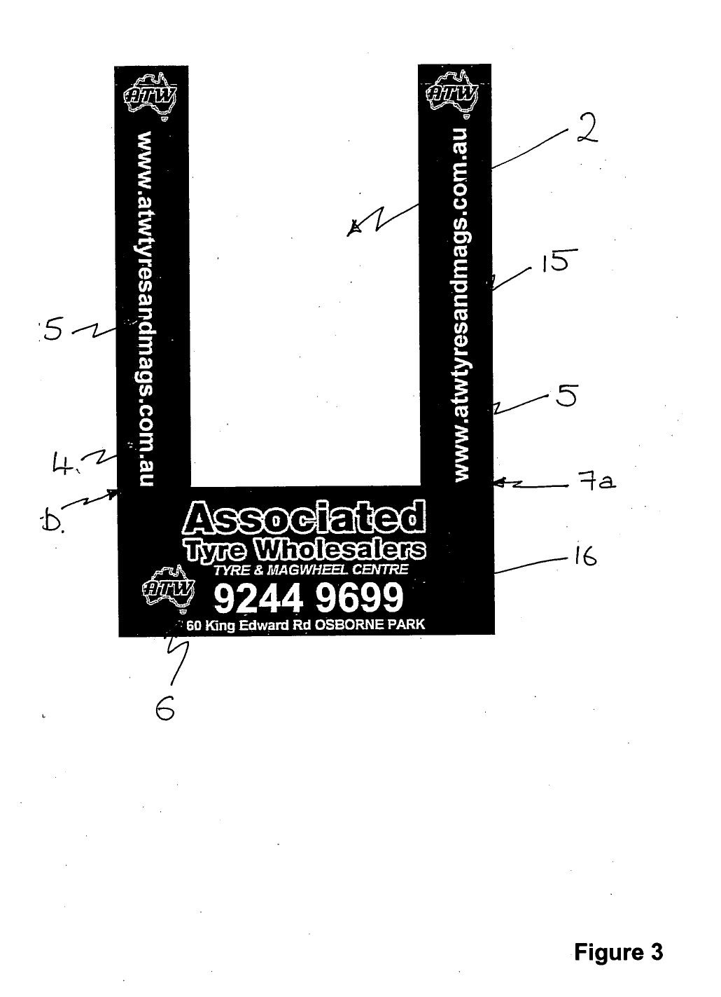

In the present embodiment, a car park 1—a section of which is schematically illustrated in FIG. 2—has three car park bays 2 defined, not by simple substantially parallel lines, but by a first area 4, a second area 5, and a third area 6. The car park 1 comprises a substantially horizontal, planar surface made of a hard, sealed material such as bitumen, asphalt, tar macadam, concrete or the like. The first, second and third areas 4, 5, 6 are all substantially rectangular in shape. FIG. 3 illustrates this in more detail. The first area 4 and the second area 5 are substantially parallel to each other and arranged in the same way as the parallel lines in a conventional car parking bay. The third area 6 is arranged substantially perpendicular to the first and second areas 4, 5 between one of the ends 7a, 7b or the first and second areas 4, 5. In this way, the first, second and third areas 4, 5, 6 define an internal portion 8 of the car parking bay 2 in which a vehicle would park.

Each of the first, second and third areas 4, 5, 6 are blocked in with a colour and have some graphical marking painted thereon. The term ‘graphic’ as used herein is used to denote letters, words, symbols, pictures and any other appropriate marking. In the present embodiment, this colour blocking and the graphical markings are in the form of advertising, such as a company logo or some other form of advertising. In the present embodiment, the graphical markings are the same in all three of the first, second and third areas 4, 5, 6. The first and second areas 4, 5 are designated a secondary advertising areas 15, and the third area 6 is designated the primary advertising area 16. Where two or more adjacent car parking bays 2 are provided, then the first area 4 of one car parking bay 2 will be adjacent the second area 5 of the adjacent car parking bay 2, thereby providing a combined area 8—see FIG. 2.

Thus, when a car parks in one of the car parking bays of the embodiment of the present invention, passengers and drivers alighting from the vehicle will immediately see the advertising or imagery present in the secondary advertising area 15. The primary advertising area 16 will be seen by drivers and pedestrians travelling through and round the car park 1.

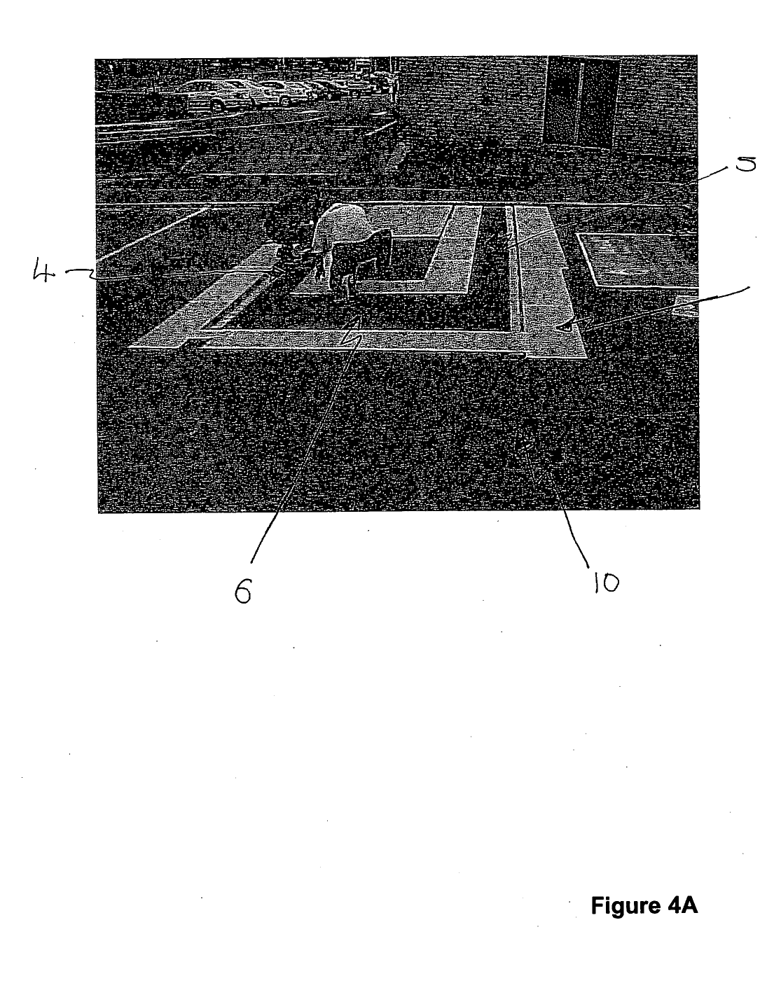

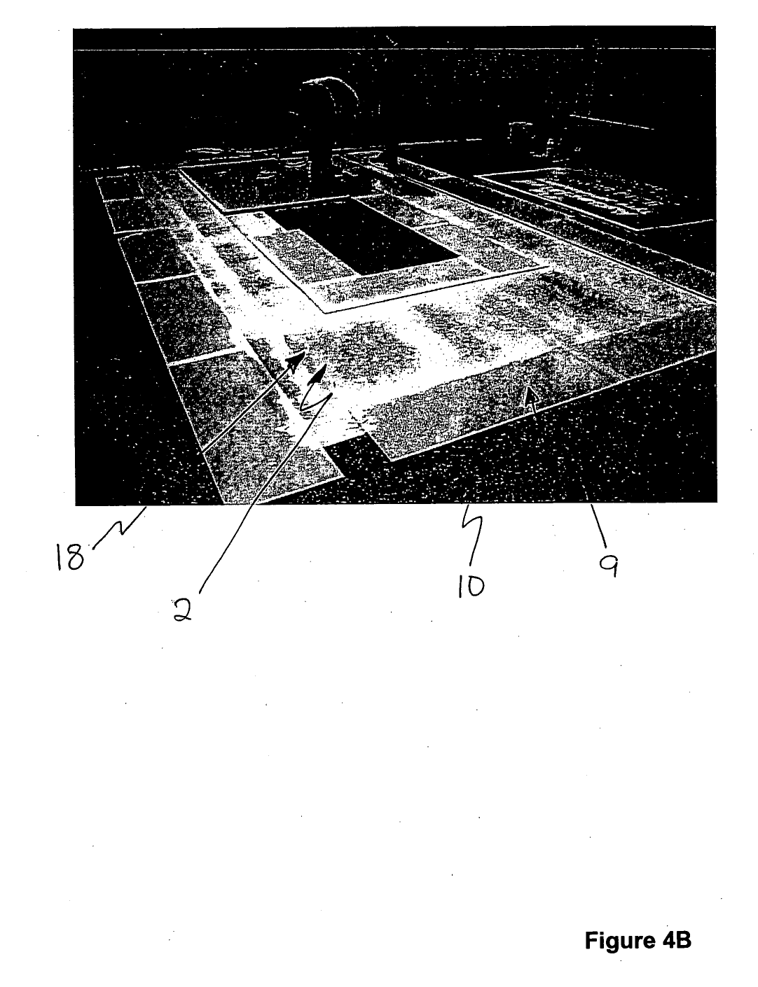

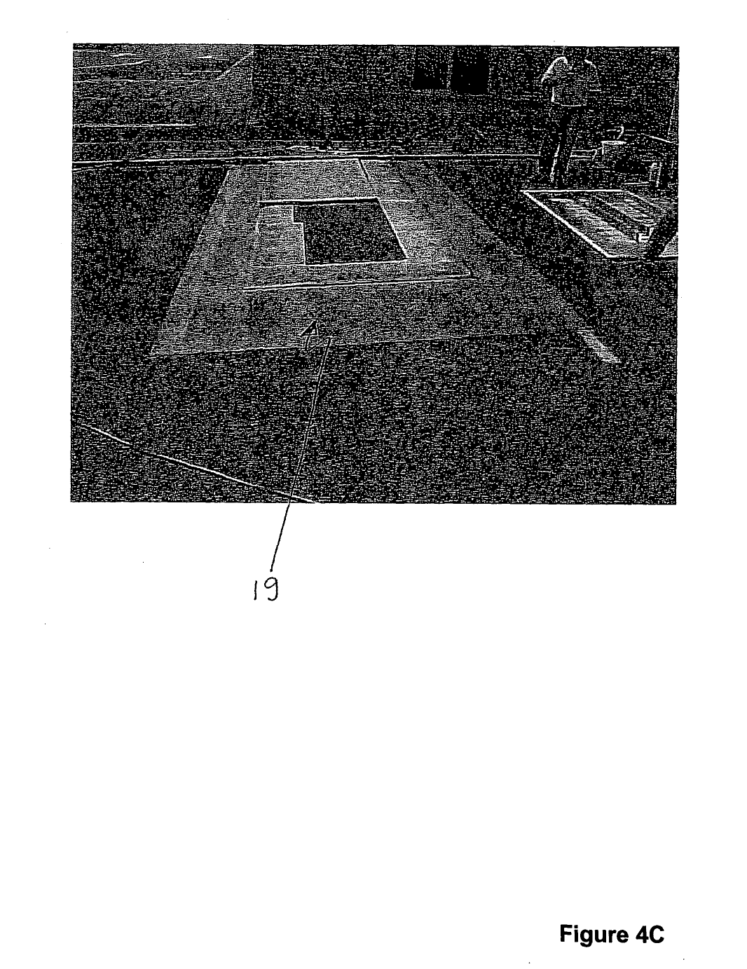

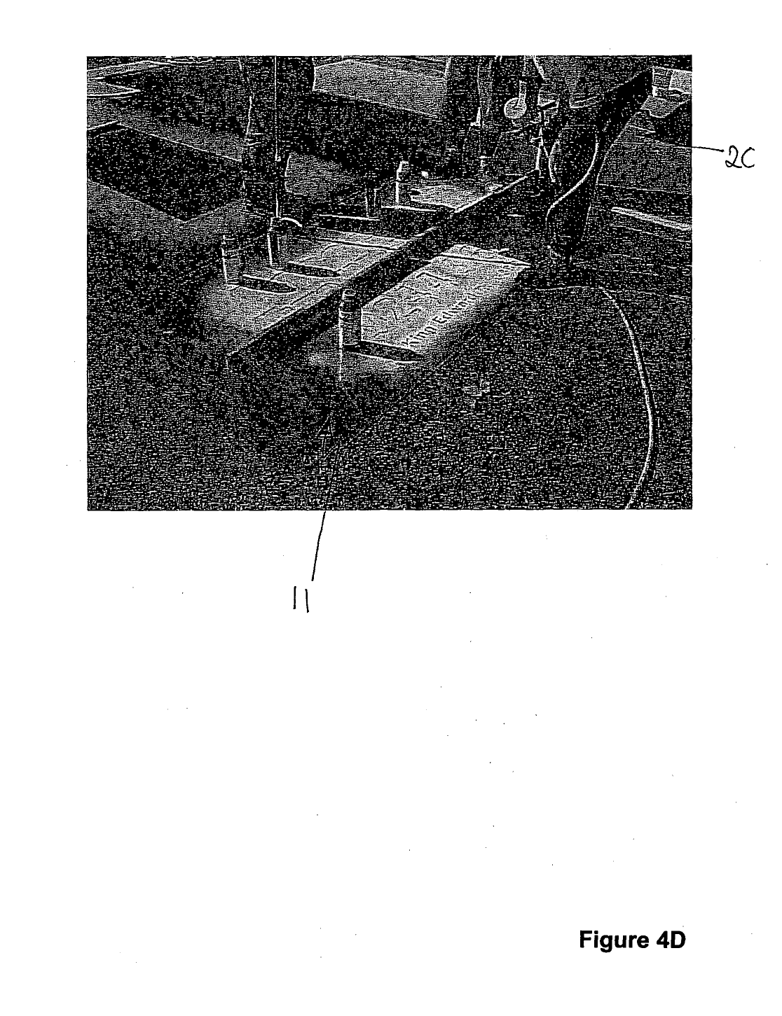

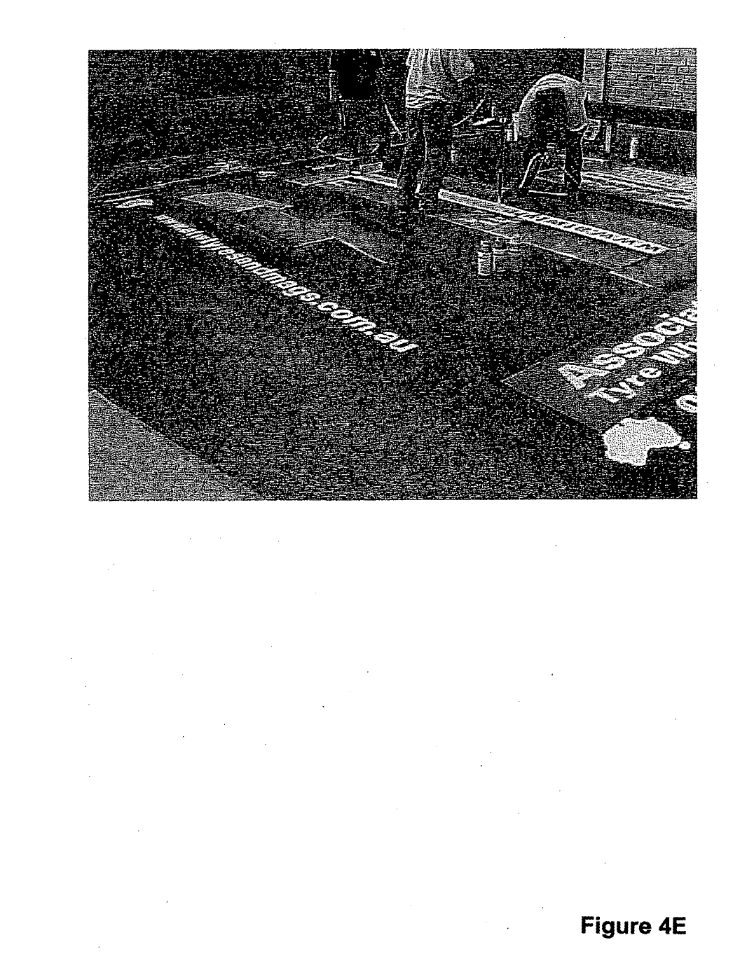

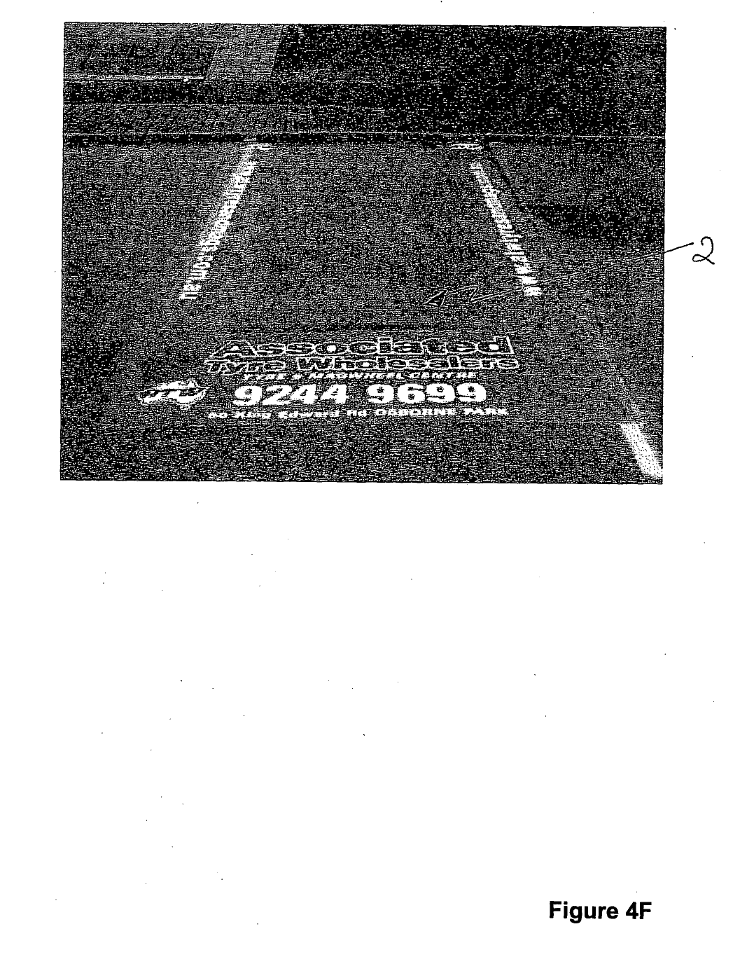

The first, second and third areas 4, 5, 6 are all made in the same way. FIGS. 4A to 4F illustrate the steps involved in creating these areas.

The template for the car parking bays of the embodiment of the invention is the car park bays defined by substantially parallel lines.

The steps for creating the parking bays 2 (and the first, second and third areas 4, 5, 6) are as follows:
1. The car park surface 10 is prepared.
2. Masking material 9 is secured to the car park surface 10 to define the first, second and third areas 4, 5, 6. For high definition edges/areas 75 mm masking tape is used. Other areas are masked by a straight edge material such as medium density fibreboard (MDF) particle board. Alternatively, a length of continuous rubber matting that is better suited to uneven surfaces can be used. This has the advantage that it removes the need for the MDF board to be weighted down to compensate for irregular/uneven surfaces. The masking material can be secured to the car park surface 10 by any suitable means. The car parking surface is conventional concrete, bitumen, asphalt or other suitable hard, sealed surface as is known to persons skilled in the art.
3. The exposed areas not covered by the masking material 9 are then spray painted with a base material 18. In this embodiment, a standard white paint is used as an undercoat and sealer. Several coats may be required depending upon the porosity of the car parking surface. White is primarily used to more faithfully reproduce brighter colours like yellows and reds.
4. Once the base material 18 is appropriately dry, then a block colour 19 is applied to the base material 18.
5. When the block colour 19 has been applied and is appropriately dry, then the masking material 9 is removed, and the requisite graphics can be applied. The graphics are applied using stencils and an airless spray system and paint gun. FIG. 4D shows this, where a stencil 11 is being applied to a portion of the third area 6 to apply some wording. Paint is applied over the stencil 11 using an airless spray system and paint gun 20. Graphics are applied to all three first and second areas 4, 5, 6 as required—see FIG. 4E. FIG. 4F illustrates a completed car parking bay 2.

The aspects of these steps will now be described in further detail below.

Stenciling

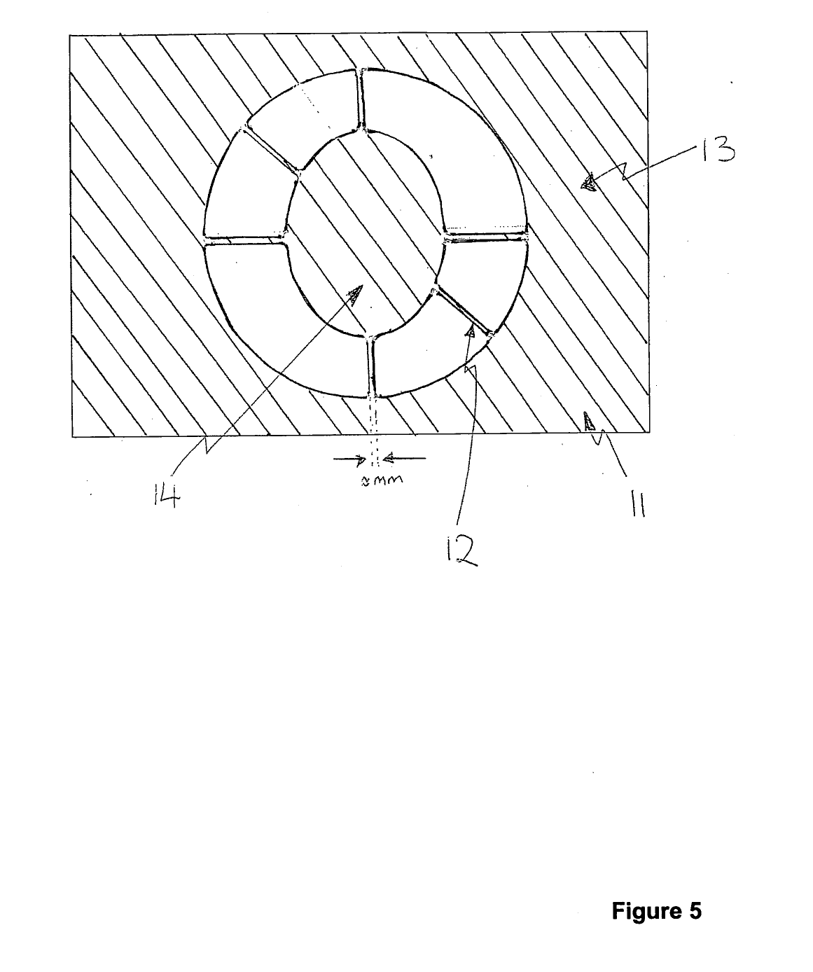

The stencil 11 used for the application of the graphics is used to apply artwork and is designed to diminish/eliminate a stencil effect of bridges/breaks common in normal stencils and plates. Standard stencils and templates are inadequate and unable to be used in regards to the finished effect and presentation standards demanded by the advertising clientele. In the present embodiment described herein, the stencils 11 are made using a computerised flatbed router machine from 0.5 mm-3 mm aluminium sheeting. The flatbed router machine is used to remove selected parts of the aluminium sheet to create apertures in the aluminium sheeting that will define the required graphics. The stencils 11 are provided with narrow ‘bridges’ 12 as required to link created apertures that define a required shape. These bridges 12 are required for certain graphics to ensure that the whole stencil 11 is retained as a single sheet while maintaining the requisite stencil apertures. The bridges 12 are less than two millimetres in width. In FIG. 5, there is shown a stencil used for forming the letter “◯”. In practice, the stencils would be more complex. The example used in FIG. 5 is used to illustrate the principle of making the stencils for embodiments of the present invention. In order to create the letter “◯”, bridges 12 connect the outer area 13 of the stencil with the inner “∘” portion 14 (in order to make the letter “◯”). Unlike conventional stencils, where the bridges are of a significant width, thereby contributing to the disjointed and low resolution appearance of the letters, the bridges 12 in the stencils 11 are of the order of a few millimetres in width.

In the artwork design stage, certain fonts/typestyles are recommended for the text elements of the message/advertisement, whereby they have a quality which either requires no bridges/breaks or substantially reduce the number of bridges/breaks in the stencil fabrication.

The narrow dimensions of the bridges 12, combined with the viscosity of the paint used allow the final painted graphics and images to appear clearly defined without any gaps. Where gaps are unavoidably present, due mainly to complex artwork/logos the operator can retouch those areas with a paint brush. This can only be done within a specific time frame, temperature being the variable, of usually 15 minutes. The time frame window of opportunity to apply this is critical for the successful bonding of the paint.

The minimization of the bridges/breaks in the stencil 11 and because the material used (aluminum) is softer and more malleable when working on uneven surfaces, then the stencils 11 are less robust and prone to damage, so great care must be taken in the handling of the stencil 11.

Surface Preparation

The surface area must be free of any debris and loose particles, where necessary the surface may also require degreasing, achieved by air or water applied under pressure.

It is important to seal surfaces that are porous, as this can affect the amount of paint product required, the labour component and faithful colour reproduction.

As mentioned above, a base layer of a white colour is first applied to ensure that bright colours such as red and yellow achieve their true colour.

Once this is achieved then the stencils can be laid on the surface in preparation for the application of the coloured layers.

Paint

The paint is an acrylic (water-based) outdoor paving paint with a durability/life of 5 to 10 years depending on weather/usage and other external elements. In this embodiment, the paint is preferably abrasive resistant, resistant to atmospheric exposure, and infra-red and ultra-violet radiation.

In the present embodiment, the paint is a water-based thermoplastic copolymer containing a polymer that enhances the hydrophobic of the cured film. Alternatively, a water-based pure acrylic solution can be used with a solvent combination that is extremely quick drying—of the order of ten minutes or so.

In a preferred embodiment, the paint is formulated with an anti-slip component and may also include an anti-graffiti component. It is also formulated with extra pigment. The addition of extra pigment is for three purposes
1. Faithful reproduction of colours demanded by the advertiser.
2. One coat application.
3. Reduce its opaqueness

It produces the required aesthetic finish when used in conjunction with the stenciling application. Its viscosity is critical during the application process when used with our unique stenciling application.

In addition to the paint layer(s) a water-based environmentally friendly phosphorescent coating can be applied to the paint. This phosphorescent coating is designed as a special effects coating that phosphoresces in the dark to provide a subtle glow. It is non-radioactive and non-toxic.

Two grades are available, one with an afterglow of about 20 minutes and the other with an afterglow of more than 6 hours.

The afterglow is the period of time that the coating will phosphoresce to provide a visible effect without reactivation. Reactivation is provided by exposure to natural or artificial light.

Generally the shorter afterglow product is used for economic reasons, the longer afterglow product being very expensive.

The phosphorescent coating is usually supplied as a light green transparent coating.

This coating performs best when applied over a white background which gives a pale green effect in the light and glows with a green-white glow.

It can be applied over other coloured paint bases—providing the base is a pale shade and not too dark—to give that predominant colour in the light, it will still glow in the dark with a green-white glow.

The glow intensity is reduced when applied over darker bases.

The heavier the coating build the more intense the glow.

The phosphorescent coating can be spray, brush or roller applied onto any surface that has been suitably prepared.

As it is entirely water-based and non-toxic it allows for easy application. For small areas brush application is typical with the ability to apply thicker films thereby giving a stronger effect. The phosphorescent would require thinning with water for application by conventional spray.

Typical application rate is approximately 8 m² per litre per coat, normally with two coats applied. The phosphorescent coating dries in about 20 minutes in good drying conditions and can be recoated in 2-4 hours.

The phosphorescent coating is a pigmented acrylic coating and has average abrasion resistance and would be expected to withstand normal foot traffic and some vehicular traffic.

Effectiveness of the phosphorescence declines, with age and is dependent on various factors such as exposure to UV, film build, and general wear and tear but most applications would expect to perform satisfactorily for period in excess of three years.

Application

As mentioned above, car park surfaces vary from very smooth concrete surfaces, to coarse bitumen surfaces.

What is required to apply the paint is an airless paint delivery system (available commercially) in combination with a hand piece containing a 2-2.5 mm nozzle, which must be operated by an experienced person, who regulates the amount of pressure delivered. The pressure is determined by the surface texture i.e.: a smooth surface uses a high pressure, while a rough surface requires a low pressure. The paint is applied in its original consistency so as not to compromise the bonding of layers, durability, coverage and drying time. The finer detail of the finished artwork is affected by incorrect application of the paint product. This determines the commercial value of the finished product.

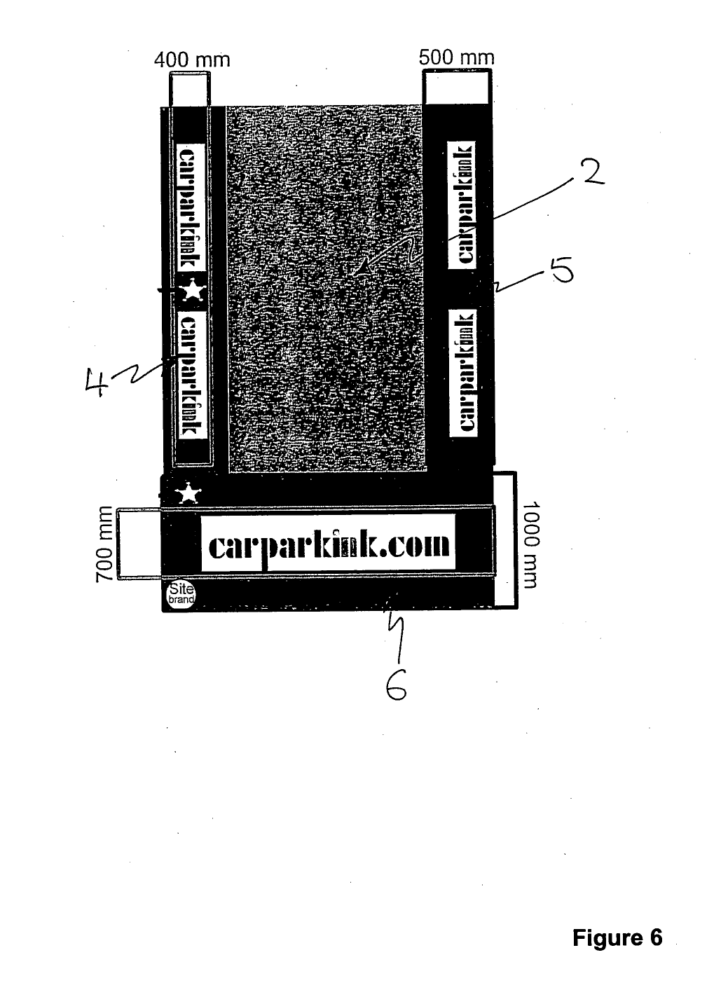

FIG. 6 illustrates typical examples of the dimensions of the first, second and third areas 4, 5, 6 of the car parking bay 2 of the embodiment of the present invention. The first and second areas 4, 5 are approximately 0.5 metre in width (with a length of about 4 metres. Advertising is placed in a central region of 0.4 metre width—see FIG. 5. The third area 6 is approximately 2.5 to 3 metres in width, and has a depth of 1 metre. Advertising is placed in a central region of a depth of approximately 0.7 metre—see FIG. 6.

In addition, the car parking bays 2 may be provided with additional signage to indicate that a car parking bay 2 is reserved for certain uses, such as by disabled persons—see FIG. 2.

The advertising that is provided in the car park bays 2, via the first, second an third areas 4, 5, 6 presents car park owners an opportunity to offset expenses of maintaining their car parks, and to profit by advertising being sold in their car parks.

In the embodiment described herein, an external service provider contracts with car park owners to sell the advertising space defined by the first, second and third areas 4, 5, 6. The external service provider provides a complete service to both the car park owner and to advertisers. They provide sales service to obtain and sell the advertising space, administration services to administer the service and also create the car parking bays 2 in accordance with the method described above. Administration, billing, and comprehensive liaison with the services of a site relations manager, provides for an effortless and cost free association by the site owner.

The external service provider determines the advertising rates, and revues market demand annually, on a site-by-site basis. The rates can be based on a number of criteria. These could include, but are not necessarily limited to, the volume of traffic that passes the shaped area, the number of vehicles that are typically stored within the shaped area, the prominence of the shaped area, or the prestige associated therewith.

Advertisers select which car parks to advertise in based on either, the demographics of the users of the car park, the geographical location of the car park, or both.

Limitations as to the type of advertisers may apply at some sites and would be primarily in regards to conflicting advertising.

The site owner also has the option of submitting an “Excluded Advertiser Schedule”.

The “Excluded Advertiser Schedule” identifies those advertisers, which are considered by the car park owner, to be in conflict with other advertising or sponsorships, associated with the site.

Key Benefits for the car park/site owner are:
No investment of capital, time or personnel.
No structures need be erected.
Income generation from an existing asset.
Reducing car park maintenance costs and eliminates tendering costs.
Branding the bays and cross media promotions that are sponsored by the advertisers.
Improving the aesthetics of the car park.

A consideration for car park owners is that each bay that carries advertising also offsets the site owners' expenses in maintaining that bay.

It follows that if 30% of the car parking bays carries advertising, then line marking maintenance costs would also be reduced by 30%, as the paid advertising replaces the need for line marking maintenance on those bays.

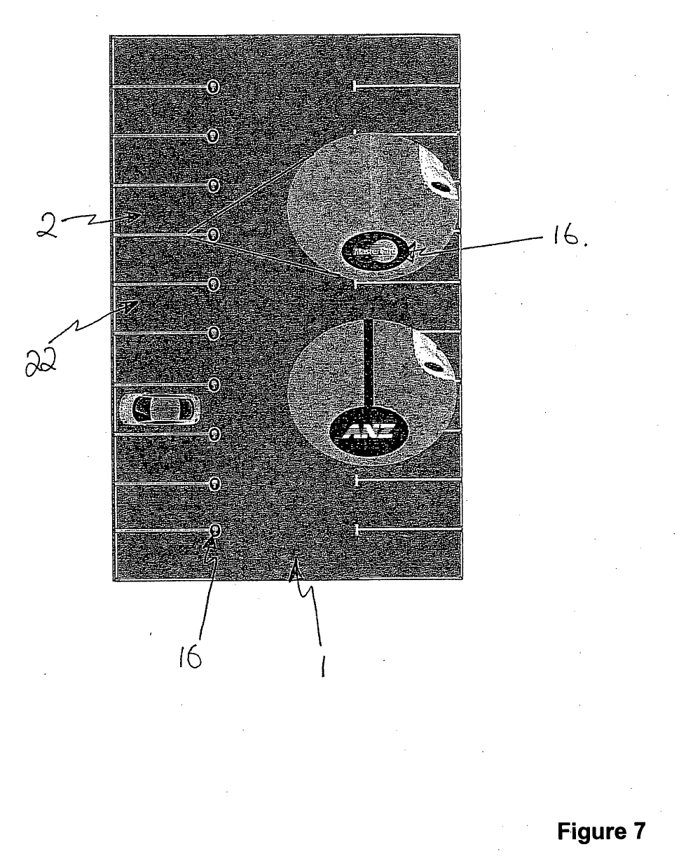

In another embodiment of the invention, primary advertising areas 16 are provide at the end of conventional car parking bay lines 2. This is illustrated in FIG. 7. The primary advertising area 16 is an oval shaped area having secondary and primary diameters of 45 cm and 75 cm with appropriate graphical markings. These primary advertising areas 16 are magnified in FIG. 7 for ease of illustration. The standard line marking is replaced with the advertiser's colour for effect. The primary advertising area 16 is made in the same way as for the first embodiment described above. Rather than having primary advertising areas 16 provided at the end of each car parking bay line 2, they could be provided at every second line i.e. one primary advertising area 16 for each car parking bay 1.

This embodiment is designed for larger sites and sold on lower traffic or outer car bays. The advertising is sold in “streets”. A “street” is sold with a minimum of 10 bays.

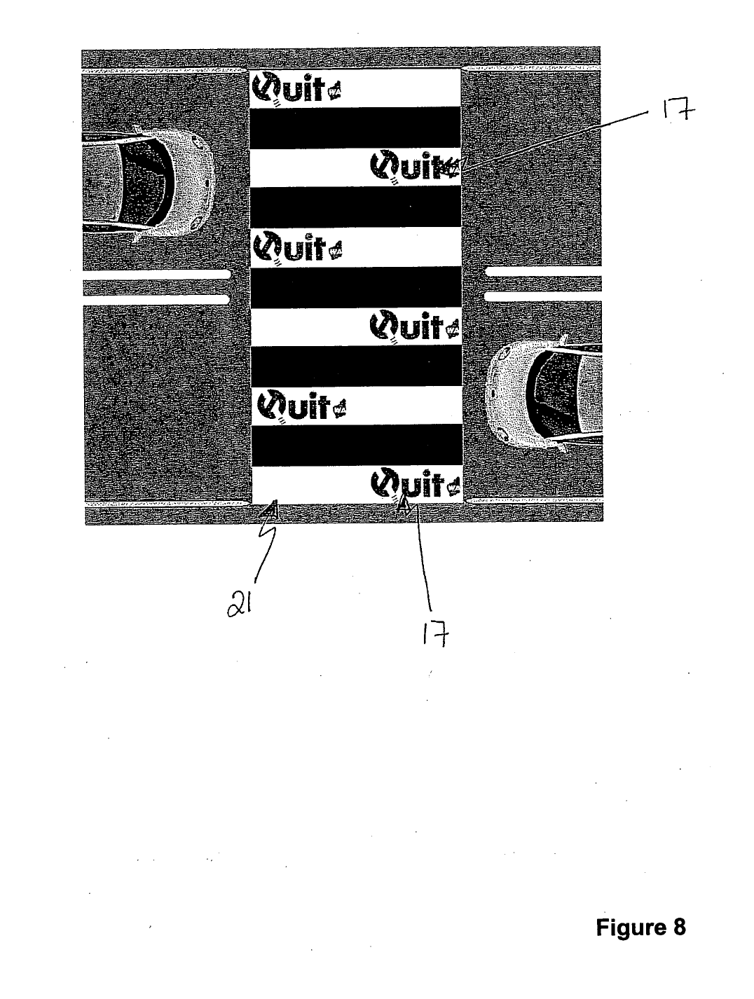

In a third embodiment, primary advertising areas 17 are provided on crosswalks. This is illustrated in FIG. 8. The graphics are created as before.

It will be evident, that such advertising can be provided in a variety of other areas, such as laybys and bus stops. The areas may be external, unsheltered areas, internal, sheltered areas, and public or private areas.

It should be appreciated by the person skilled in the art that the invention is not limited to the embodiments described.

Modifications and variations such as would be apparent to a skilled addressee are deemed to be within the scope of the present invention.

1. An advertising system provided within a vehicle parking area, the vehicle parking area comprising a substantially planar surface having a plurality of delineated portions for parking of a vehicle therein, whereby the delineated portions comprise a substantially planar primary advertising portion provided on a section of the substantially planar surface.

2. An advertising system according to claim 1, wherein the delineated portions are defined by a pair of substantially parallel lines provided on the substantially planar surface whereby the primary advertising portion is provided substantially perpendicular to the pair of parallel lines and between opposing ends of each of the pair of parallel lines.

3. An advertising system according to claim 1, wherein the delineated portions are defined by a pair of substantially parallel elongate areas comprising a second advertising area, and by the primary advertising area provided substantially perpendicular to the pair of parallel lines and between opposing ends of each of the pair of substantially parallel elongate areas.

4. An advertising system according to claim 1, wherein the delineated portions are defined by a pair of substantially parallel lines provided on the substantially planar surface whereby the primary advertising portion is a blocked area provided adjacent the ends of one or both of the pair of substantially parallel lines.

5. An advertising system according to claim 4, wherein the blocked area is oval in shape.

6. A method for creating an advertising system for areas, having a substantially horizontal planar surface, the advertising system comprising a primary advertising portion provided upon the substantially planar surface painted thereon, the primary advertising portion comprising painted graphics, the method comprising the steps of:
preparing the substantially planar surface;
masking portions of the area to define the primary advertising portion;
providing a base material in the defined primary advertising portion;
providing a coat of material on the base material; and
creating graphics on the coat using a stencil.

7. A method according to claim 6, wherein the masking is achieved using a straight edge material.

8. A method according to claim 6, wherein the masking is achieved using a masking tape.

9. A method according to claim 6, wherein the masking is achieved using rubber matting.

10. A method according to claim 6, wherein the graphics are applied using an airless spray system and paint gun.

11. A method according to claim 6, further comprising adding a phosphorescent coating.

12. A method according to claim 6, wherein the area comprises a public external area.

13. A method of advertising goods and/or services by providing advertising on a substantially horizontal planar surface provided in an area, whereby the advertising is in a primary advertising portion painted on the substantially horizontal planar surface.

14. A method according to claim 13, wherein the method further comprises the step of providing a secondary advertising portion, whereby the secondary advertising portion comprises first and second substantially parallel elongate rectangular areas, and the primary advertising portion comprising a third substantially rectangular area arranged between the first and second rectangular areas to thereby delineate a substantially rectangular portion of the external public area.

15. A method according to claim 13, comprising the steps of providing first and second substantially parallel lines on the substantially horizontal planar surface, the first and second substantially parallel lines delineating a substantially rectangular portion of the area, whereby the primary advertising portion is substantially oval in shape and is provided at a free end of the substantially parallel lines.

16. A method according to claim 13, wherein the area comprises a defined pedestrian area, the primary advertising portion being provided on the pedestrian area.

17. A method according to claim 13, wherein the area comprises a public external area.

18. A method of advertising comprising the steps of:
contracting with the owner of an area to provide advertising services;
providing advertising spaces within the area; and
selling the advertising spaces to advertisers.

19. A method according to claim 18, wherein the area comprises an external public area.

20. A stencil for use in creating graphics for a substantially horizontal surface comprising a metallic sheet having one or more apertures provided therein.

21. A stencil according to claim 20, wherein the apertures are linked by one or more bridges.

22. A stencil according to claim 21, wherein the bridges have a width of less than 2 mm.

23-25. (canceled)
